(19) United States
(12) Patent Application Publication
(10) Pub. No.: US 2007/0145646 A1
(43) Pub. Date: Jun. 28, 2007

(54) Arrangement and method for manufacturing pet bottle with handle formed at body part by injection blow molding, and pet bottle manufactured by them

(76) Inventor: Ja Yeon Cho, Seoul (KR)

Correspondence Address: MERCHANT & GOULD PC, P.O. BOX 2903, MINNEAPOLIS, MN, 55402-0903, US

(21) Appl. No.: 10/583,536

(22) PCT Filed: Dec. 17, 2004
(86) PCT No.: PCT/KR04/03341

§ 371 Date: Jun. 15, 2006

(30) Foreign Application Priority Data
Dec. 19, 2003 (KR) 10-2003-0093910

(51) Int. Cl. B29C 49/08

(52) U.S. Cl. 264/529; 264/537; 264/538; 425/527; 425/522

(57) ABSTRACT

The present invention relates to arrangement and method for manufacturing a PET bottle having a handle formed on a body by a continuous process by means of an injection blow molding method, and a PET bottle manufactured thereby. The arrangement comprises a preform blow mold for blowing air into a preform to expand the preform in a predetermined ratio to a complete shape so as to allow a handle section to be compressed, a blow mold having a handle forming portion for compressing both sides of the bottle to form the handle section, a cutting mold including a mold punch for cutting off a compressed portion of the handle section compressed by the handle forming portion, a bonding apparatus for bonding the compressed portion of the handle section compressed by the handle forming portion or a cut-off portion remaining in the handle section after cutting off the compressed portion of the handle section by means of the cutting mold, and a conveyer for conveying the preform or the molded PET bottle while clamping a neck of the preform or a neck of the molded PET bottle. The method comprises the steps of performing a first blowing operation to blow compressed air into a preform manufactured by injection molding in order to form a first hollow PET container after mounting the preform to a preform blow mold, performing a second blowing operation to blow compressed air into the first PET container in order to form a second PET container having a handle section formed on a predetermined area of a body after mounting the first PET container to a blow mold having a handle forming portion, cutting off a compressed portion of the handle section of the second PET container in order to form a third PET container, and bonding a cut-off portion of the handle section of the third PET container remaining after the step c) in order to form a fourth PET container. The PET bottle having the handle formed on the body is formed by use of the above arrangement and method.

### TECHNICAL FIELD

The present invention relates to a method for manufacturing a polyethylene terephthalate (which will be referred to as “PET”) bottle having a handle formed on a body and a PET bottle manufactured thereby, and, more particularly, to arrangement and method for manufacturing a PET bottle having a handle formed on a body through a continuous process by an injection blow molding method, and a PET bottle manufactured thereby.

### BACKGROUND ART

In general, thermal plasticity is a measure of the ability of a material, such as plastics, to be softened or melted by heating so that, when the softened or melted material is pushed into the mold or compressed against a inner wall of the mold, the material can be variously changed in shape according to the shape of a mold, and then to be solidified when the material is cooled.

Methods of manufacturing a bottle by taking advantage of the thermal plasticity of plastics include a blow molding method, which is mainly used for manufacturing hollow products, such as a bottle. Basically, the blow molding method comprises pre-molding a (test tube-shaped) resin pipe at an appropriate temperature, what is referred to as a parison or preform, through extrusion or injection, inserting the parison into a mold having a cavity formed therein, and blowing air into the preform to expand the parison into a shape corresponding to the shape of the cavity. Such blow molding methods are generally applied to thermoplastic resins, and include an extrusion or direct blow molding method, an injection blow molding method, a stretch blow molding method, and the like. In manufacturing of the PET bottles, the injection stretch blow molding method has been widely used

The extrusion blow molding method is a molding method in which a blowing operation is performed after extruding melted resin using an extruder, and, more specifically, comprises forming a pipe-shaped parison using a thermoplastic resin supplied from a hopper and then melted within an extrusion screw, blowing the parison to be expanded to a predetermined shape within a mold, cooling the parison having the predetermined shape to provide a desired product of a predetermined shape, and ejecting the product from the mold.

The extrusion blow molding method has advantages in that it is possible to form a container having a large volume, and a container having a handle, and in that it can be applied to molding of most plastic materials, such as polyethylene (PE), polypropylene (PP), polyvinyl chloride (PVC), and the like. However, the extrusion blow molding method has a disadvantage in that it cannot be applied to PET materials having a property of low melt strength.

In order to allow the extrusion blow molding method to be applied to such PET materials, a modified PET resin is often used, but it is more expensive than typical PET resins while having fewer applications than stretched PET resin.

Meanwhile, the injection blow molding is a molding method combining an injection molding and the blow molding method, and, unlike the extruding step for the parison in the extrusion blow molding method, it comprises injecting a parison or a preform stick into an injection mold, and blowing the parison in a blow mold.

As described above, in the case of the PET resin with the low melt strength, since it is difficult to apply the extrusion blow molding method thereto due to a draw down phenomenon on the parison, the injection blow molding method which does not cause the draw down phenomenon on the parison is usually used in the art. In particular, in the case of the PET resin, the injection stretch blow molding method is mainly applied, which bi-axially stretches a parison longitudinally by means of a stretch rod while blowing the parison within the blow mold.

When producing the containers having the handle formed on the body by means of the extrusion blow molding method, since a portion corresponding to the handle must be compressed together with rest portions of the parison during a process of compressing the parison between mold halves, the parison must be extruded to a pipe shape having a large diameter. Moreover, since the parison must be expanded to a predetermined shape corresponding to that of a cavity in the mold as soon as the parison is extruded to the pipe shape, operations such as temperature treatment and the like cannot be smoothly performed, thereby making it difficult to manufacture a container having a uniform thickness. Moreover, since the mold asymmetrically surrounds the parison, it is difficult to manufacture a container having a uniform thickness, and there is an increase of unnecessary portions, which must be removed after ejection of products from the mold.

In comparison to the extrusion blow molding method, the injection blow molding method has advantages in that it can provide a molded product with even distribution of the material in the product while having uniformity in weight, volume and thickness of the product, and in that a design molding of a neck requiring accuracy is possible. However, there are disadvantages in that it is necessary to provide a highly advanced technology, especially, in manufacturing a mold and in a molding method, and to install two types of mold. Moreover, unlike the extrusion blow molding method, there is a problem in that the injection blow molding method cannot form the container having the handle formed on the body.

### DISCLOSURE

### Technical Problem

Therefore, the present invention has been made in view of the above problems, and it is an object of the present invention to provide arrangement and method for manufacturing a PET bottle having a handle formed on a body through an injection blow molding method, designed to allow the PET bottle having the handle formed on the body, which cannot be manufactured by the conventional injection blow molding method, to be manufactured in such a manner that the handle is formed on the body during a process of blowing, as with an extrusion blow molding method, and a PET bottle manufactured thereby.

### Technical Solution

In accordance with an aspect of the present invention, the above and other objects can be accomplished by the provision of an arrangement for manufacturing a PET bottle having a handle formed on a body, comprising: a preform blow mold for blowing air into a preform to expand the preform in a predetermined ratio to a complete shape so as to allow a handle section to be compressed; a blow mold having a handle forming portion for compressing both sides of the bottle to form the handle section; a cutting apparatus including a mold punch for cutting off the compressed portion of the handle section compressed by the handle forming portion; a bonding apparatus for bonding the compressed portion of the handle section compressed by the handle forming portion or a cut-off portion remaining in the handle section after cutting off the compressed portion of the handle section by the cutting apparatus; and a conveyer for conveying the preform or the molded PET bottle while clamping a neck of the preform or a neck of the molded PET bottle.

In accordance with another aspect of the present invention, a method of manufacturing a PET bottle having a handle formed on a body is provided, comprising the steps of: a) performing a first blowing operation to blow compressed air into a test tube-shaped preform in order to form a first hollow PET container after heating the test tube-shaped preform manufactured by injection molding and conveying the preform to a preform blow mold; b) performing a second blowing operation to blow compressed air into the first PET container in order to form a second PET container having a handle section formed thereon after conveying the first PET container to a blow mold having a handle forming portion; c) cutting off a compressed portion of the second PET container using a mold punch in a cutting mold for cutting off the compressed portion of the handle section in order to form a third PET container after conveying the second PET container to the cutting mold; and d) injection molding a cut-off portion in the handle section of the third PET container remaining after the step c) into a predetermined shape in order to form a fourth PET container after conveying the third PET container to an insert injection mold for injection molding the cut-off portion of the handle section remaining after the step c).

In accordance with yet another aspect of the present invention, a PET bottle manufactured by the arrangement or the method as described above is provided.

### DESCRIPTION OF DRAWINGS

The above and other objects, features and other advantages of the present invention will be more clearly understood from the following detailed description taken in conjunction with the accompanying drawings, in which:

FIGS. 1 to 3 are cross-sectional views illustrating a conventional process of manufacturing a preform by means of an injection molding method;

FIG. 4 is a perspective view illustrating an overall construction of an arrangement for manufacturing a PET bottle having a handle formed on a body through an injection blow molding method in accordance with the present invention;

FIG. 5 is a top view illustrating the arrangement shown in FIG. 4;

FIGS. 6 to 10 are perspective views illustrating products obtained at respective steps during an injection blow molding process for forming a PET bottle having a handle formed on a body in accordance with Embodiment 1 of the present invention;

FIGS. 11 to 15 are schematic perspective views illustrating apparatuses used for the respective steps during the injection blow molding process for forming the PET bottle having the handle formed on the body in accordance with Embodiment 1 of the present invention;

FIGS. 16 and 17 are perspective views illustrating products obtained by the third step and the fourth step of a method in accordance with Embodiment 2 of the present invention; and

FIG. 18 is a perspective view illustrating products obtained by the fifth step of a method in accordance with Embodiment 3 of the present invention.

### BEST MODE

Reference will now be made in detail to the embodiments of the present invention with reference to the accompanying drawings, wherein like components will be denoted by like reference numerals throughout the drawings.

### Embodiment 1

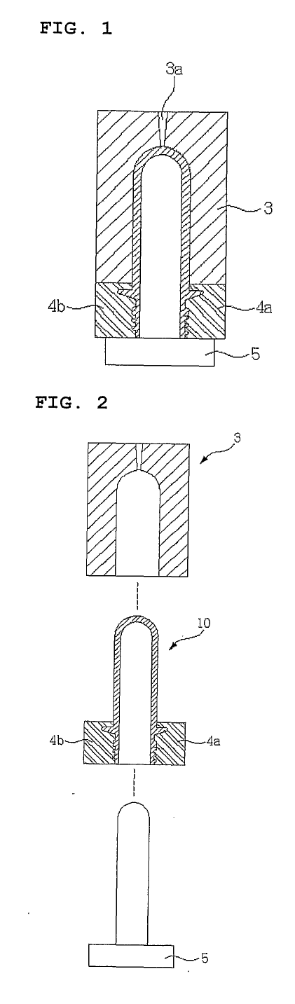

FIGS. 1 to 3 are cross-sectional views illustrating a conventional process of manufacturing a preform by means of injection molding.

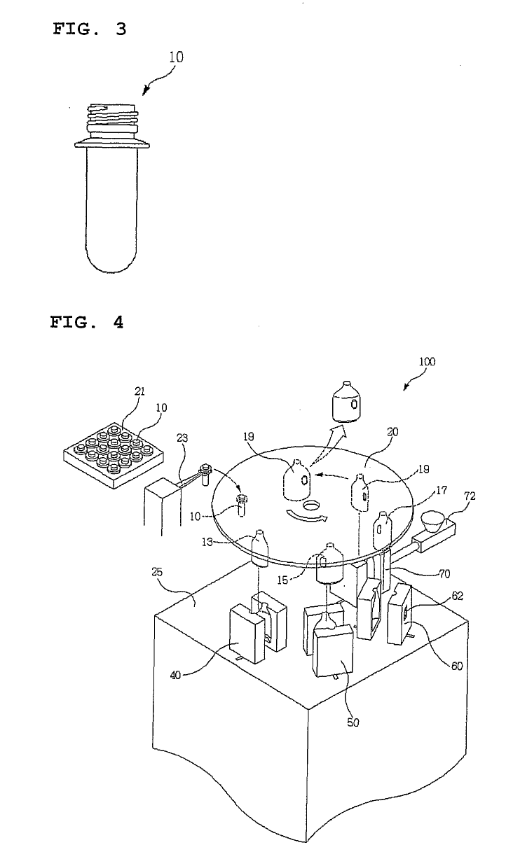

As descried above, for forming a PET bottle having a handle formed on a body through an injection blow molding method (more preferably, an injection stretch blow molding method), first, a test tube-shaped preform 10 is formed. As shown in the drawings, the preform 10 is formed to a test tube shape by injecting resin around a core mold 5 by a cavity mold 3, which is an injection mold. At this time, the injection mold has a gap formed between the core mold 5 and the cavity mold 3 for forming the test-tube shaped preform 10, so that the resin is poured into the gap through a gate 3a of the cavity mold 3, and fills the gap, thereby forming the preform 10. The core mold 5 is formed at an upper portion with a neck mold 4, which is divided into two parts 4a and 4b, and forms an entrance of the bottle. The molded preform 10 is separated from the cavity mold 3 and the core mold 5. The preform 10 separated from the core mold 4 is shown in FIG. 3.

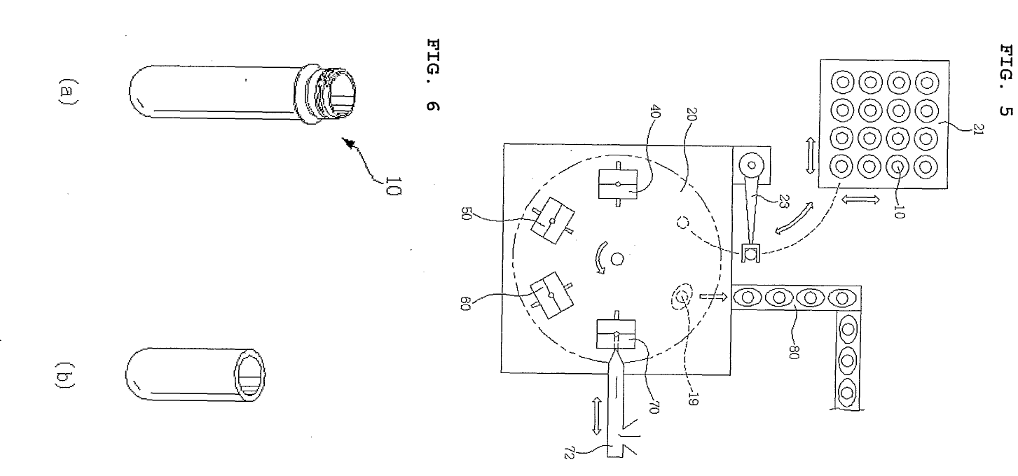

FIG. 4 is a perspective view illustrating an overall construction of an arrangement for manufacturing a PET bottle having a handle formed on a body through an injection blow molding method in accordance with the present invention, and FIG. 5 is a top view illustrating the arrangement shown in FIG. 4.

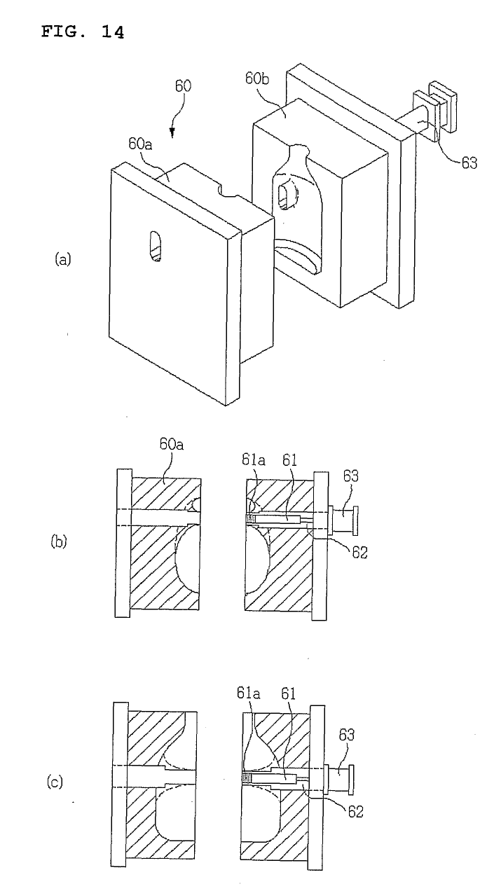

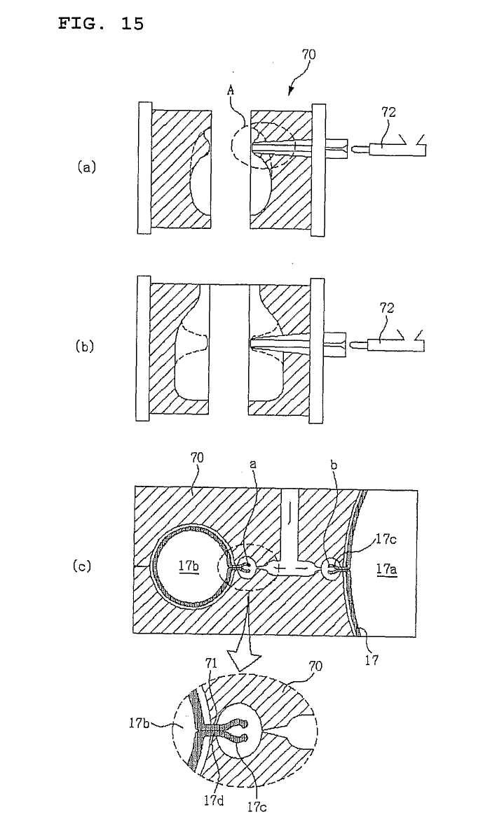

Referring to FIGS. 4 and 5, the arrangement 100 for manufacturing the PET bottle through the injection blow molding method in accordance with the invention comprises a preform heating box 21 to receive and heat a plurality of preforms 10, a robot arm 23 to deliver the heated preforms 10 from the preform heating box 21, a rotational circular plate 20 to receive the heated preforms 10 from the robot arm 23 and to convey the preforms to respective stages of a process for manufacturing the PET bottle, a preform blow mold 40, a blow mold 50 having a handle forming portion, a cutting mold 60 having a mold punch as a cutting apparatus, and an insert injection mold 70 as a bonding apparatus, in which the preform blow mold 40, the blow mold 50, the cutting mold 60, and the insert injection mold 70 are located below the rotational circular plate 20, and spaced a predetermined distance from each other on a supporting die 25 such that a continuous process can be performed by rotation of the rotational circular plate 20. Additionally, the arrangement is provided at the sides of the supporting die 25 with a series of auxiliary apparatuses, such as an injector 72, a conveyor 80 to convey a completed PET container 19, and the like. In particular, the cutting mold 60 is formed at the side surface thereof with a hole 62 into which the mold punch 61 (see FIGS. 14a to 14c) is inserted. The injector 72 is located at the side of the insert injection mold 70. Although the construction of the arrangement shown in FIGS. 4 and 5 is based on a blow molding method adopting a two-stage type injection blow molding, it is needless to say that the present invention is applicable to one-stage type injection blow molding.

The process of manufacturing the PET bottle having the handle formed on the body by means of the injection blow molding apparatus in accordance with the invention shown in FIGS. 4 and 5 will be described for respective steps thereof as follows.

FIGS. 6 to 10 are perspective views sequentially illustrating products obtained at the respective steps during the injection blow molding process for forming the PET bottle having the handle formed on the body in accordance with Embodiment 1 of the present invention, in each of which (a) is a perspective view of the products formed at the respective steps, and (b) is a perspective view of a lower portion of the products cut off from a middle portion thereof.

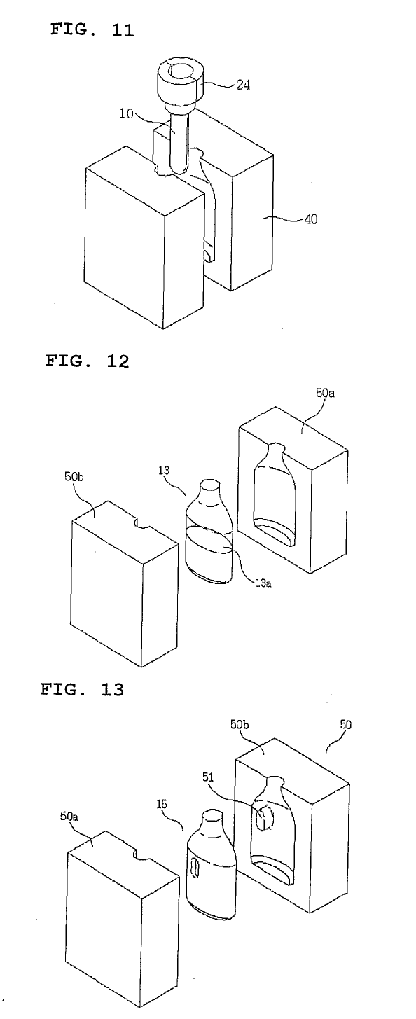

FIGS. 11 to 15 are schematic perspective views illustrating apparatuses used in the respective steps during the injection blow molding process for forming the PET bottle having the handle formed on the body in accordance with Embodiment 1 of the invention.

(1) The First Step

Referring to FIGS. 4 and 5, after being received and heated within the preform heating box 21, a plurality of preforms 10 are sequentially clamped, and delivered one by one by means of the robot arm 23 to the rotational circular plate 20 such that the heated preforms are mounted to a predetermined position under the bottom of the rotational circular plate 20. Then, the rotational circular plate 20 rotates to a predetermined angle, and places an associated preform 10 mounted under the rotational circular plate 20 to the preform blow mold 40 in order to perform a first blowing operation of the present invention. In the preform blow mold 40 (see FIG. 11), compressed air is blown into the preform 10, while a stretching rod (not shown) stretches the preform 10 from a preform holder 24 holding the preform 10. In the present embodiment, although the injection stretch blow molding method is illustrated as being used for manufacturing the PET bottle, the present invention is not limited to this method, and it is apparent that the injection blow molding method may also be employed.

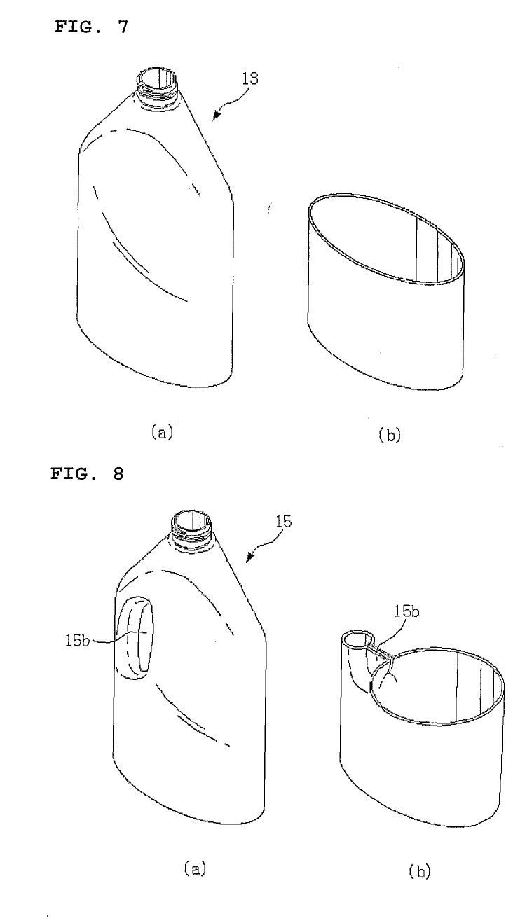

By such a first blowing operation, a first PET container 13 as shown in FIG. 7 is formed, in which the first PET container 13 has an elliptical hollow portion 13a formed at the center thereof (see FIG. 7). This is for the purpose of providing an appropriate shape for forming a handle section on the PET bottle through a series of molding processes described hereinafter. However, it should be understood that the present invention is not limited to the elliptical shape as mentioned above. FIG. 12 shows the first PET container 13 produced after the first blowing operation.

In accordance with the present embodiment, since the PET bottle has therein the elliptical hollow portion, which has directionality in a circumferential direction, and the handle is also disposed at one portion of the PET bottle, it is desirable that, when mounting the preform 10 on the blow molds 40, 50, 60 and 70 of the present invention, the preform 10 on the blow molds 40, 50, 60 and 70 are mounted in the same direction. This can be achieved by fixing the direction of the PET bottle mounted under the rotational circular plate 20. As one example, a groove (not shown) may be formed on a predetermined position of a neck of the preform 10 so as to allow the groove formed on the neck of the preform 10 to be caught by a predetermined portion under the bottom of the rotational circular plate 20 when the rotational circular plate 20 clamps the preform 10, so that the PET bottle is prevented from rotating under the bottom of the rotational circular plate 20, thereby allowing the preform 10 of the PET bottle to be accurately located into the respective blow molds.

Meanwhile, when forming the preform 10 having a circular hollow portion as shown in FIG. 6 into the first PET container 13 having the elliptical hollow portion as described above (see FIG. 7), the preform must be formed to have a uniform thickness. As one method of achieving this purpose, there is a method of creating a temperature variation in the circumferential (rotational) direction of the preform by heating an outer peripheral portion of the preform corresponding to a minor axis of an ellipsoid of the first PET container 13 after blow molding the preform higher than an outer peripheral portion of the preform corresponding to a major axis of the ellipsoid of the first PET container 13 after blow molding the preform, such that the outer peripheral portion of the preform corresponding to the minor axis of the ellipsoid is extended more than the outer peripheral portion of the preform corresponding to the major axis of the ellipsoid, thereby allowing the hollow portion of the first PET container to have the elliptical shape having the uniform thickness.

It is desirable that, when forming the first PET container 13 in the first blowing operation, the first PET container 13 is formed to 60˜80% of the volume of a completed PET bottle design. Additionally, for preventing the product from being cooled upon a second blowing operation, which follows the first blowing operation, the temperature of the first blow mold 40 must be appropriately controlled.

(2) The Second Step

Next, a second blowing operation is performed to form a second PET container 15 as shown in FIG. 8 after mounting the first elliptical PET container 13 formed by the first blowing operation to the blow mold 50 having the handle forming portion. During the second blowing operation, both sides of a predetermined portion of a body of the first elliptical PET container 13 formed by the first blow molding are compressed by molding protrusions 51, formed on inner surfaces of mold halves to act as the handle forming portion for forming the handle section on the first PET container 13, while the remainder of the body of the first PET container 13 is secondarily stretched by blowing. FIG. 13 shows the second PET container 15 ejected after the second blowing operation. With this second blowing operation, the body of the second PET container 15 is formed into the completed PET bottle design.

Meanwhile, the first elliptical PET container 13 primarily stretched in the first blowing operation is thin, and vulnerable to variation in outer temperature. In particular, considering that the handle section is compressed by the mold piece 51, and thus suffers from a cooling phenomenon causing the temperature to be rapidly decreased, the blow mold 50 having the handle forming portion must be appropriately controlled in temperature. Additionally, since the second blowing operation is continuously performed after primarily stretching the first PET container, and the stretchability of the first PET container is different from that of the preform 10, the temperature and the blowing pressure for the primarily stretched container must be changed.

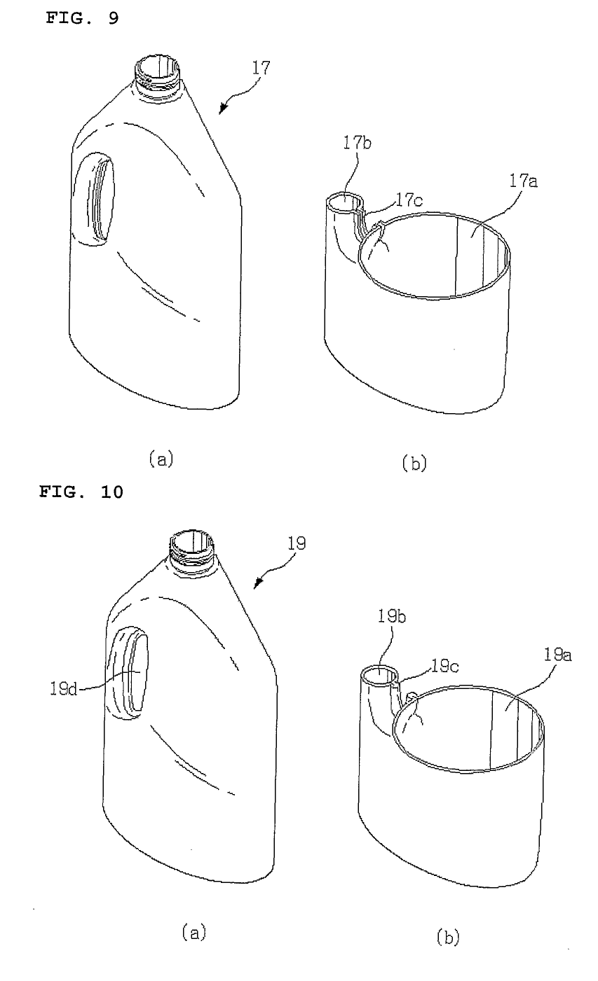

Additionally, for ensuring that, after a compressed portion 15b of the handle section of the second PET container 15 is cut off in a process described hereinafter, ends 17c (see FIG. 9) of a cut-off portion remaining in the handle section are bonded to an insert injection portion 19c (see FIG. 10) formed through an insert injection process, which is a bonding process, each of the molding protrusions 51 (see FIG. 13) is preferably formed on the surface thereof with irregularities, which cause the ends 17c (see FIG. 15) of the cut-off portion remaining in the handle section to be slightly widened from each other.

(3) The Third Step

Next, when the second PET container 15 is provided by the second blowing operation, the second PET container 15 is formed at one portion thereof with the handle section of a depressed and raised feature, which will be formed to the handle upon completion of manufacturing the PET bottle. That is, since the compressed portion 15b (see FIG. 8) of the handle section is not completely separated, it must be removed by cutting. For this purpose, after the second PET container 15 is conveyed to the cutting mold 60 as shown in FIG. 14, the third step of the present invention will be performed. For reference, in (a) to (c) of FIG. 14, (a) is a perspective view illustrating an overall construction of the cutting mold 60, (b) is a horizontal sectional view of the cutting mold 60 shown in (a) of FIG. 14, and (c) is a longitudinal sectional view thereof.

With the second PET container 15 as shown in FIG. 8 equipped to the cutting mold 60, as a hydraulic pressure cylinder 63 equipped at the side surface of the cutting mold 60 applies force to the mold punch 61 inserted into a through-hole formed at the side surface of the cutting mold 60, the mold punch 61 is pushed into the compressed portion 15b of the handle section, and cuts off the compressed portion 15b, thereby forming a third PET container 17. Then, the compressed portion 15b of the handle section is ejected through the mold piece 60a at one side of the cutting mold 60 by the mold punch 61, and is then recycled. In FIG. 9, reference numerals 17a and 17b denote containing spaces defined in the third PET container 17, respectively.

Meanwhile, in the case where the second PET container 15 has a thick wall, it is effective to install a heater 61a separately to an end of the mold punch 61. At this time, the temperature of the heater 61a is preferably in the range of 260˜300° C., and must be appropriately controlled to prevent the formation of yarns or threads. Moreover, in order to prevent crystallization around the cut portion, it is desirable that the cutting process is performed as quickly as possible. After the cutting process, the ends 17c of the cut-off portion remaining in the handle section after cutting off the compressed portion may be partially widened.

When the compressed portion of the handle section is cut off by means of the mold punch 61 while being heated by the heater 61a equipped to the end of the mold punch 61, the cut-off portion can be slightly melted by the heat of the heater 61a, and becomes blunt, thereby forming a non-crystallized portion (see 17c of FIG. 15). The non-crystallized portion serves to enhance bonding efficiency with another PET part, which will be introduced during an insert injection process described below.

(4) The Fourth Step

Meanwhile, it would seem possible that the ends of the cut-off portion remaining in the handle section can be bonded to each other by heating and compressing the cut-off portion remaining in the handle section after the cutting process using the mold punch 61. However, since the PET material stretched by the blowing process has a fixed molecular orientation, it is difficult to bond the PET material by heating and compressing. Additionally, even if bonding is performed in such a way, the bonding strength is insufficient to permit the completed bottle to be filled with certain items, such as liquid. Accordingly, in order to ensure satisfactory bonding effects, instead of bonding the ends of the cut-off portion remaining in the handle section by compressing both sides of the cut-off portion simultaneously with the cutting process in the third step, it is desirable to perform a bonding process for the cut-off portion remaining in the handle section in the fourth step after the cutting process in the third step.

As for the bonding process for the cut-off portion remaining in the handle section after the cutting process, the fourth step is performed after the third PET container 17 with the compressed portion 15b removed from the handle section, as shown in FIG. 9, is conveyed to the insert injection mold 70, acting as the bonding apparatus, as shown in FIG. 15.

For reference, in FIG. 15, (a) is a horizontal sectional view illustrating the insert injection mold 70, (b) is a longitudinal sectional view thereof, and (c) is an enlarged view of part A, where insert injection molding is performed in a state that insert injection mold halves 70 are engaged with each other.

As shown in the drawings, in the fourth step of the present invention, with the injector 72 located at the side of the insert injection mold 70, injection molding is performed by means of the injector 72 along a cutting line on the ends 17c (see FIG. 9) of the cut-off portion remaining in the handle section of the third PET container 17.

When the third PET container 17 is mounted in the insert injection mold 70, both sides of an intermediate portion 17d of the cut-off portion remaining in the handle section are compressed by a predetermined portion 71 (see FIG. 15), acting as a compressing member, of the insert injection mold 70, thereby preventing a sealing material from being leaked through a gap between the intermediate portions 17d into the space 17b upon insert injection molding. At the same time, the ends 17c of the handle section of the third PET container 17 are sealed through insert injection molding. That is, spaces a and b shown in FIG. 15 are filled with the sealing material, thereby providing an inner circumference of a handle section 19d with a smooth and volumetric shape, so that when a user grips the handle of the PET bottle, the inner circumference of the handle section 19d provides a convenient grip for the PET bottle. At this time, the dimensions of an insert injection molded part 19c are determined to maintain a constant strength according to thickness and shape of the bottle so as to provide an assistant function in strengthening of the handle section.

The fourth PET container 19 molded by the insert injection mold 70 has the insert injection molded part 19c formed around the ends 17c of the cut-off portion remaining in the handle section of the third PET container 17 after the cutting process, and is a completed PET bottle.

Meanwhile, as for another bonding process for the cut-off portion remaining in the handle section after the cutting process, the fourth step may be performed by means of ultrasonic bonding instead of insert injection molding. Ultrasonic bonding is a method of welding overlapping portions of the plastic to each other after generating heat on the overlapping portions by means of ultrasonic vibration, and is applicable not only to bonding of a thin material but also to bonding a thick plastic material. In particular, in the case of the PET materials, it is impossible or difficult to apply heat plat bonding, impulse bonding or high frequency bonding to bonding of the PET materials, whereas the ultrasonic bonding can be applied thereto by use of the high frequency oscillator, vibrator, tool horn, and the like.

As with the bonding process using the insert injection mold as described above, with both sides of the intermediate portion 17d (see FIG. 9) of the handle section of the third PET container 17 compressed, high frequency vibration is generated on the overlapping portions, so that the overlapping portions are heated and welded to each other.

### Embodiment 2

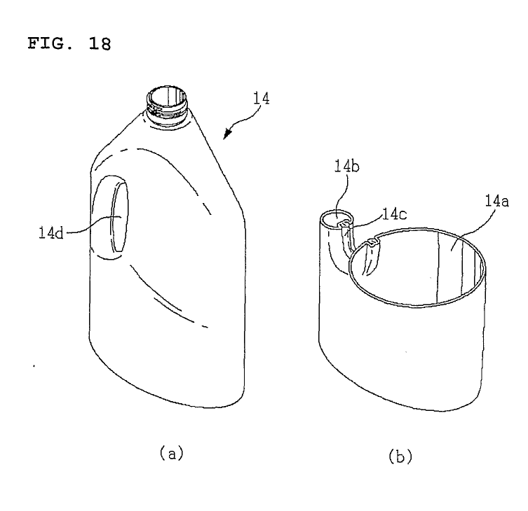

According to Embodiment 1, the method of manufacturing the PET bottle comprises the steps of performing the first blowing operation to blow compressed air into the preform 10 in the preform blow mold 40 in order to form the first hollow PET container 13 (the first step); performing the second blowing operation to blow compressed air into the first PET container 13 in order to form the second PET container 15 in the blow mold 50 having the molding protrusions 51 (the second step); cutting off the compressed portion 15b of the second PET container 15 in order to form the third PET container 17 (the third step) and bonding the ends 17c remaining in the handle section of the third PET container 17 in order to form the fourth PET container (when bonding is performed during insert injection molding, the fourth PET container has the shape shown in FIG. 10, and when bonding is performed during ultrasonic bonding, the fourth PET container has a similar shape shown in FIG. 17) (the fourth step).

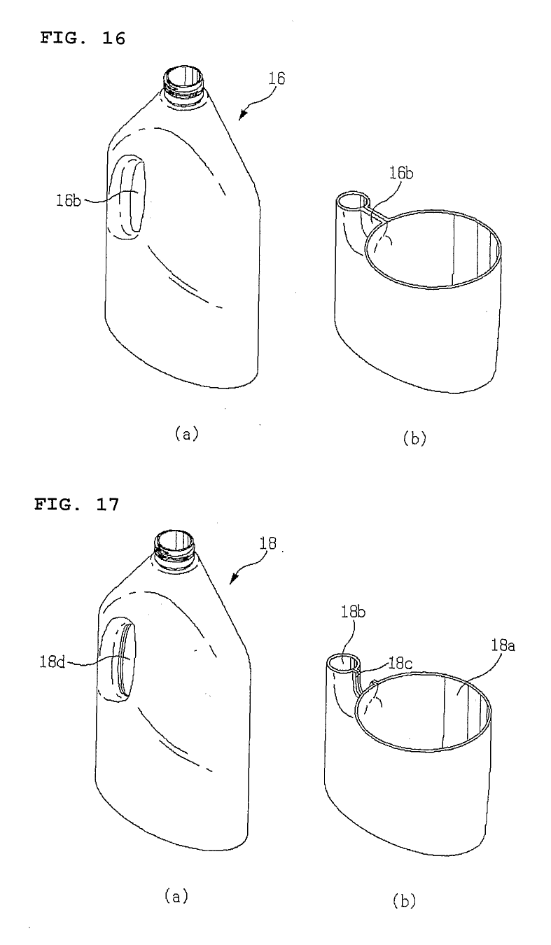

FIGS. 16 and 17 are perspective views illustrating products obtained by the third step and the fourth step of a method in accordance with Embodiment 2 of the present invention, respectively.

Referring to FIGS. 16 and 17, the method according to Embodiment 2 comprises the same steps as those of the method according to Embodiment 1, except for the sequence of the third step and the fourth step (more specifically, the ultrasonic bonding process) of Embodiment 1. That is, in the third step of the method according to Embodiment 2, both sides of the compressed portion 15b in the handle section of the second PET container 15 shown in FIG. 8 are bonded by the ultrasonic bonding process, thereby forming a third PET container 16 shown in FIG. 16, and in the fourth step of Embodiment 2, the compressed and bonded portion 16b of the handle section of the third PET container 16 is cut off, thereby forming a fourth PET container 18 shown in FIG. 17.

According to Embodiment 2, the second and third steps of the method may be performed separately. Alternatively, the second and third steps of the method may be performed concurrently, by means of the blow mold 50 (see FIG. 13) having an ultrasonic vibrator (not shown) equipped at the distal end of one of the molding protrusions 51 of the blow mold 50 for forming the second PET container 15. In the latter case, there are effects of reducing the time for manufacturing the products as well as manufacturing costs.

### Embodiment 3

FIG. 18 is a perspective view illustrating products obtained by the fifth step of a method in accordance with Embodiment 3 of the present invention. Embodiment 3 consists of five steps.

The first step of the method according to Embodiment 3 is the same as that of the first step of the method according to Embodiments 1 and 2. That is, the first blowing operation is performed after the preform is mounted to the preform blow mold 40.

Unlike the second step of the method according to Embodiments 1 and 2, in the second step of the method according to Embodiment 3, the first PET container 13 is not completely expanded to the completed PET bottle design by the blowing operation. Instead, according to Embodiment 3, the method comprises an additional fifth step for performing a blowing operation to stretch the PET container to the completed PET bottle design.

That is, the second step of the method according to Embodiment 3 is provided by modifying the second step of the method according to Embodiments 1 and 2, in which the second blowing operation is performed to form a second PET container having a shape of 70˜90% of the volume of the completed PET bottle design by blowing compressed air into a first PET container 13 to such an extent that a handle section of the first PET container 13 is not deformed when compressing the handle section with the blow mold 50 having the molding protrusions 51.

In the second step of the method according to Embodiment 3, although the second PET container (similar to the PET container shown in FIG. 8) is also formed with a compressed portion 15b of the handle section by compressing the first PET container 13 expanded to the shape of 60˜80% of the volume of the completed PET bottle design in the first step, the second PET container is maintained in a state of being blown to the shape of 70˜90% of the volume of the completed PET bottle design.

Although the third and fourth steps of the method according to Embodiment 3 are the same as those of the method according to Embodiments 1 or 2, it is desirable that the operating temperature of the first step is maintained in the third and fourth steps due to the blowing operation for forming the PET container into the completed PET bottle in the fifth step as described below. More specifically, as with Embodiment 1, the compressed portion 15b of the second PET container is cut off in the third step, and ends 17c of a cut-off portion remaining in the handle section of the third PET container are bonded by means of insert injection or the ultrasonic bonding in the fourth step. Alternatively, as with Embodiment 2, both sides of the compressed portion 15b are bonded through the ultrasonic bonding in the third step, and the compressed portion 16b is cut off in the fourth step.

In the fifth step of the method according to Embodiment 3, an additional blowing operation is performed to form a fifth PET container 14 as shown in FIG. 18 after mounting a fourth PET container (similar to the container as shown in FIG. 10 or in FIG. 17, but in a state of being blown to the shape of 70˜90% of the volume of the completed PET bottle design) to a blow mold (not shown) having a completed PET bottle shape and having a handle forming portion which will penetrate the body of the PET container in the fifth step. In comparison with the blow mold 50 having the molding protrusions 51 shown in FIG. 13, the blow mold for the third blowing operation of Embodiment 3 is different from the blow mold 50 in that molding protrusions acting as the handle forming portion formed on blow mold halves contact each other through an opening 19d or 18d of the handle section as shown in FIG. 10 or in FIG. 17. If the blowing process is performed in the fifth step after finishing the bonding process in the third and fourth steps, an effect of providing bonded portion 19c or 18c in FIG. 10 or in FIG. 17 embedded into the container is provided. FIG. 18 show the fifth PET container provided by the fifth step after finishing the bonding process, for example, by means of insert injection molding, in which the fifth PET container 14 has the insert injection molded part 19c of FIG. 10 embedded in the container, and the handle section has the penetrated shape 14d.

### Embodiment 4

Embodiment 4 is provided by combining the second step of Embodiment 2 in which the second blowing operation is performed by use of the blow mold 50 having the handle forming portion, and the third step of Embodiment 2 in which the compressed portion 15b is bonded by ultrasonic bonding. Specifically, Embodiment 4 is characterized in that formation and bonding of a compressed portion 15b in a handle section are performed at the same time by use of a handle forming device including a handle forming portion and an ultrasonic bonding apparatus installed on the distal end of the handle forming portion.

In a method of manufacturing a PET bottle having a handle formed on a body according to Embodiment 4, the first step is the same as that of Embodiments 1 to 3. That is, in the first step of the method, the first blowing operation is performed after mounting the preform 10 on the preform blow mold 40.

In the second step, the formation and bonding of the compressed portion 15b of the handle section are performed concurrently in such a manner that with both sides of a first PET container compressed, ultrasonic bonding is performed on the compressed portion 15b at the same time by use of the handle forming device including the handle forming portion and the ultrasonic bonding apparatus installed on the distal end of the handle forming portion. A second PET container formed by the second step is similar to the container shown in FIG. 16.

In the third step, a compressed and bonded portion 16b of the handle section is cut off.

In the fourth step, a second blowing operation is performed after mounting a third PET container (similar to the container shown in FIG. 17, but in a state of being blow molded to the shape of 60˜80% of the volume of the completed PET bottle design) to a blow mold (not shown) having a completed PET bottle shape and having a handle forming portion which will penetrate the body of the PET container. In the fourth step, a fourth PET container having the shape of the completed PET bottle is formed (as with the PET container as shown in FIG. 18, the fourth PET container also has the embedded portion 14c, but is different from the PET container shown in FIG. 18 in that the embedded portion 14c is bonded by ultrasonic bonding).

Although the above embodiments are described with respect to the PET resin, it is apparent that the present invention is also applicable to manufacturing of various bottles using plastic materials other than PET resin.

### INDUSTRIAL APPLICABILITY

As is apparent from the above description, according to the present invention, the PET bottle having the handle formed on the body, which cannot be manufactured by conventional extrusion blow molding methods, is formed by the continuous injection blow molding method, thereby providing convenience in use, enhancing efficiency upon manufacturing the PET bottle having the handle formed on the body, eliminating labor and costs related to recycling of the handle made of a different plastic material from that of the body in the conventional PET container, and preventing environmental pollution and economic loss due to waste of the handles of the conventional PET container.

Although the injection blow molding method is an appropriate method for forming the PET bottle having the handle formed on the body, due to its advantage in that a container having a uniform thickness can be produced thereby, it is applicable to the containers made of plastic materials other than the PET resin, and it is obvious that the shape of the container is not limited to ellipsoid.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An arrangement for manufacturing a PET bottle having a handle formed on a body, comprising:
a preform blow mold for blowing air into a preform to expand the preform in a predetermined ratio to a complete shape so as to allow a handle section to be compressed;
a blow mold having a handle forming portion for compressing both sides of the bottle to form the handle section;
a cutting apparatus including a mold punch for cutting off the compressed portion of the handle section compressed by the handle forming portion;
a bonding apparatus for bonding the compressed portion of the handle section compressed by the handle forming portion or a cut-off portion remaining in the handle section after cutting off the compressed portion of the handle section; and
a conveyer for conveying the preform or the molded PET bottle while clamping a neck of the preform or a neck of the molded PET bottle.

2. The arrangement as set forth in claim 1, further comprising a bottle-shaped blow mold having a handle forming portion configured to penetrate the body of the bottle upon compressing both sides of the bottle.

3. The arrangement as set forth in claim 1, wherein the bonding apparatus is an insert injection mold for bonding ends of the cut-off portion to each other by insert injection, the insert injection mold including a compressing member for compressing both sides of an intermediate portion of the cut-off portion remaining in the handle section after cutting off the compressed portion of the handle section.

4. The arrangement as set forth in claim 1, wherein the bonding apparatus is an ultrasonic bonding apparatus for compressing and bonding the compressed portion of the handle section or the cut-off portion remaining in the handle section after cutting off the compressed portion of the handle section.

5. An arrangement for manufacturing a PET bottle having a handle formed on a body, comprising:
a preform blow mold for blowing air into a preform to expand the preform in a predetermined ratio to a complete shape so as to allow a handle section to be compressed;
a handle forming device having a handle forming portion for compressing both sides of the bottle so as to form the handle section;
an ultrasonic bonding apparatus equipped to an end of the handle forming portion for bonding a compressed portion at both sides of the handle section;
a cutting apparatus including a mold punch for cutting off the compressed portion of the handle section compressed by the handle forming portion; and
a conveyer for conveying the preform or the molded PET bottle while clamping a neck of the preform or a neck of the molded PET bottle.

6. A method of manufacturing a PET bottle having a handle formed on a body, comprising the steps of:
a) performing a first blowing operation to blow compressed air into a preform manufactured by injection molding in order to form a first hollow PET container after mounting the preform to a preform blow mold;
b) performing a second blowing operation to blow compressed air into the first PET container in order to form a second PET container having a handle section formed on a predetermined area of the second PET container after mounting the first PET container to a blow mold having a handle forming portion;
c) cutting off a compressed portion of the handle section of the second PET container in order to form a third PET container; and
d) bonding a cut-off portion remaining in the handle section of the third PET container after the step c) in order to form a fourth PET container.

7. The method as set forth in claim 6, wherein, in the step d), the fourth PET container is formed by bonding the cut-off portion remaining in the handle section of the third PET container to a predetermined thickness through insert injection molding in an insert injection mold.

8. The method as set forth in claim 6, wherein, when the second PET container has a large thickness, the step c) is performed by use of a mold punch having a heater installed on an end of the mold punch.

9. The method as set forth in claim 6, wherein, in the step d), the fourth PET container is formed by bonding the cut-off portion remaining in the handle section of the third PET container to a predetermined thickness by means of ultrasonic bonding.

10. A method of manufacturing a PET bottle having a handle formed on a body, comprising the steps of:
a) performing a first blowing operation to blow compressed air into a preform manufactured by injection molding in order to form a first hollow PET container after mounting the preform to a preform blow mold;
b) performing a second blowing operation to blow compressed air into the first PET container in order to form a second PET container having a handle section formed on a predetermined area of the second PET container after mounting the first PET container to a blow mold having a handle forming portion;
c) bonding a compressed portion of the handle section of the second PET container by means of ultrasonic bonding in order to form a third PET container; and
d) cutting off the compressed portion of the handle section of the third PET container in order to form a fourth PET container.

11. A method of manufacturing a PET bottle having a handle formed on a body, comprising the steps of:
a) performing a first blowing operation to blow compressed air into a preform manufactured by injection molding in order to form a first hollow PET container after mounting the preform to a preform blow mold;
b) performing a second blowing operation to blow compressed air into the first PET container in order to form a second PET container having a handle section formed on a predetermined area of the second PET container after mounting the first PET container to a blow mold having a handle forming portion;
c) cutting off a compressed portion of the handle section of the second PET container in order to form a third PET container; and
d) bonding a cut-off portion remaining in the handle section of the third PET container after the step c) in order to form a fourth PET container; and
e) blowing compressed air into the fourth PET container in order to form a fifth PET container after mounting the fourth PET container to a bottle-shaped blow mold hang a handle forming portion penetrating a body of the fourth PET container upon blowing.

12. The method as set forth in claim 11, wherein, in the step d), the fourth PET container is formed by bonding the cut-off portion of the handle section of the third PET container to a constant thickness by means of insert injection molding in an insert injection mold or by means of ultrasonic bonding.

13. A method of manufacturing a PET bottle having a handle formed on a body, comprising the steps of:
a) performing a first blowing operation to blow compressed air into a preform manufactured by injection molding in order to form a first hollow PET container after mounting the preform to a preform blow mold;
b) performing a second blowing operation to blow compressed air into the first PET container in order to form a second PET container having a handle section formed on a predetermined area of the second PET container after mounting the first PET container to a blow mold having a handle forming portion;
c) bonding a compressed portion of the handle section of the second PET container by means of ultrasonic bonding in order to form a third PET container;
d) cutting off the compressed portion of the handle section of the third PET container in order to form a fourth PET container; and
e) blowing compressed air into the fourth PET container in order to form a fifth PET container after mounting the fourth PET container to a bottle-shaped blow mold having a handle forming portion penetrating a body of the fourth PET container upon blowing.

14. A method of manufacturing a PET bottle having a handle formed on a body, comprising the steps of:
a) performing a first blowing operation to blow compressed air into a preform manufactured by injection molding in order to form a first hollow PET container after mounting the preform to a preform blow mold;
b) compressing both sides of a handle section of the first PET container by use of a handle forming device having a handle forming portion while bonding a compressed portion of the handle section by use of an ultrasonic bonding apparatus installed on an end of the handle forming portion in order to form a second PET container;
c) cutting off the compressed portion of the handle section of the second PET container in order to form a third PET container; and
d) blowing compressed air into the third PET container in order to form a fourth PET container after mounting the third PET container to a bottle-shaped blow mold having a handle forming punch penetrating a body of the fourth PET container upon blowing.

15. (canceled)

16. A PET bottle, comprising:
a) a handle integrally formed on a body during a blowing operation performed with blow mold;
b) a cut-off portion formed on an inner circumference of the handle; and
c) a bonded part of the cut-off portion formed by ultrasonic bonding or insert injection molding.

17. The PET bottle as set forth in claim 16, wherein the bonded part of the cut-off portion is embedded in the bottle.
